(19) United States
(12) Patent Application Publication
(10) Pub. No.: US 2023/0337626 A1
(43) Pub. Date: Oct. 26, 2023

(54) HINGE FOR A SECURITY GATE

(71) Applicant: North States Industries, Inc., Plymouth, MN (US)

(72) Inventors: Hua Chen, Lishi (CN); Xuanquan Liu, Hangzhou (CN)

(21) Appl. No.: 18/168,047

(22) Filed: Feb. 13, 2023

Related U.S. Application Data
(60) Provisional application No. 63/334,319, filed on Apr. 25, 2022.

(51) Int. Cl. A01K 1/035

(52) U.S. Cl. CPC A01K 1/035

(57) ABSTRACT

A hinge assembly for connecting panels of a gate. The hinge assembly includes a locking mechanism and an actuator that causes the locking mechanism to engage and disengage. When the locking mechanism is disengaged, the hinge permits pivoting of the panels relative to each other to different panel configurations at which the locking mechanism can be re-engaged to lock the gate in one of the different panel configurations.

### TECHNICAL FIELD

The present disclosure is directed to hinges that can lock in different positions.

### BACKGROUND

Security gates are commonly used to lock or close passageways such as conventional doorways and entrances to stairwells. The purpose of such gates is primarily security, such as keeping small children from accessing stairwells that could present a hazard, and also confinement, such as confining a pet to a particular room during the night.

A typical security gate is formed from one or more panels, each panel including a frame surrounding a lattice structure (e.g., a mesh) or series of bars formed therebetween so that one can see through the gate when the gate is in place.

Some security gates are free-standing, such that the security gate need not be secured to a doorway or other structure to remain upright.

### SUMMARY

In general terms, the present disclosure is directed to an improved hinge.

In further general terms, the present disclosure is directed to an improved hinge assembly.

In further general terms, the present disclosure is directed to a security gate having an improved hinge.

In further general terms, the present disclosure is directed to a free standing security gate having an improved hinge.

According to certain aspects of the present disclosure, a security gate includes: panels; and a hinge assembly having an unlocked configuration and a locked configuration, the hinge assembly coupling the panels to each other, the hinge assembly including: a bracket that mounts to one of the panels; a pin about which the bracket is configured to pivot when the hinge assembly is in the unlocked configuration; a locking element; and an actuator, the actuator being configured to cause the locking element to lockingly engage and to disengage the bracket, the hinge assembly being in the locked configuration when the locking element lockingly engages the bracket.

### DESCRIPTION OF THE DRAWINGS

FIG. 1 is a perspective view of an example security gate according to the present disclosure, the security gate being in a straight configuration.

FIG. 2 is a further perspective view of the security gate of FIG. 1 in the straight configuration.

FIG. 3 is a further perspective view of the security gate of FIG. 1, the security gate being in an angled configuration.

FIG. 4 is an enlarged view of a portion of the security gate of FIG. 1.

FIG. 5 is an enlarged view of a portion of the security gate of FIG. 1 in an angled configuration.

FIG. 6 is a partially exploded, perspective view, of the portion of the security gate of FIG. 4.

FIG. 7 is a perspective view of the hinge assembly of the security gate of FIG. 1.

FIG. 8 is a further perspective view of the hinge assembly of FIG. 7.

FIG. 9 is an exploded view of the hinge assembly of FIG. 7.

FIG. 10 is a further exploded view of the hinge assembly of FIG. 7.

FIG. 11 is a perspective view of one of the mounting brackets of the hinge assembly of FIG. 7.

FIG. 12 is a further perspective view of the mounting bracket of FIG. 11.

FIG. 13 is a perspective view of the locking component of the hinge assembly of FIG. 7.

FIG. 14 is a further perspective view of the locking component of FIG. 13.

FIG. 15 is a top view of the security gate of FIG. 1.

FIG. 16 is a cross-sectional view of the security gate of FIG. 1 along the line A-A in FIG. 15.

FIG. 17 is an enlarged, perspective view of a portion of the security gate shown in FIG. 16, with the hinge assembly being in a straight and locked configuration.

FIG. 18 is an enlarged perspective view of the portion of FIG. 17, with the hinge assembly being in a straight and unlocked configuration.

FIG. 19 is an enlarged perspective view of the portion of FIG. 17, with the hinge assembly being in an angled and unlocked configuration.

FIG. 20 is an enlarged perspective view of the portion of FIG. 17, with the hinge assembly being in an angled and locked configuration.

### DETAILED DESCRIPTION

The present disclosure is directed towards a security gate. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

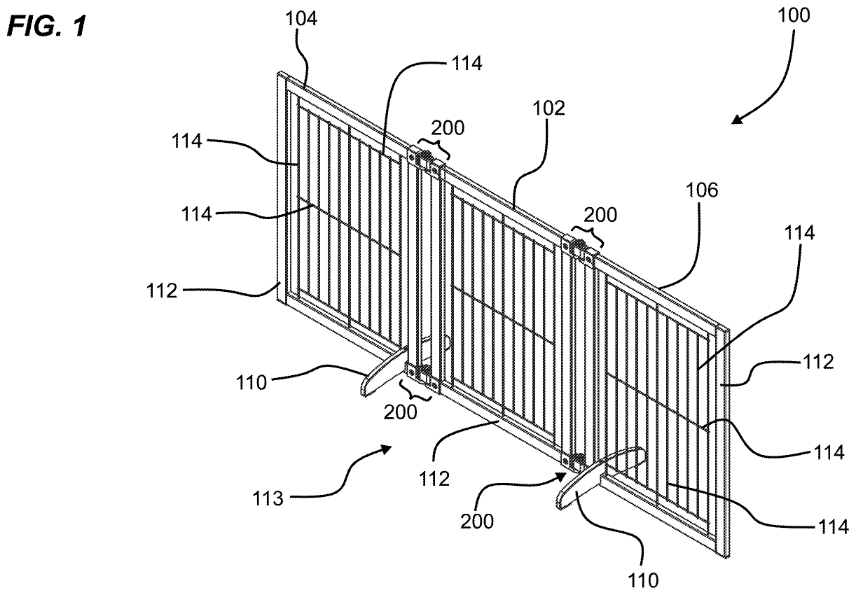

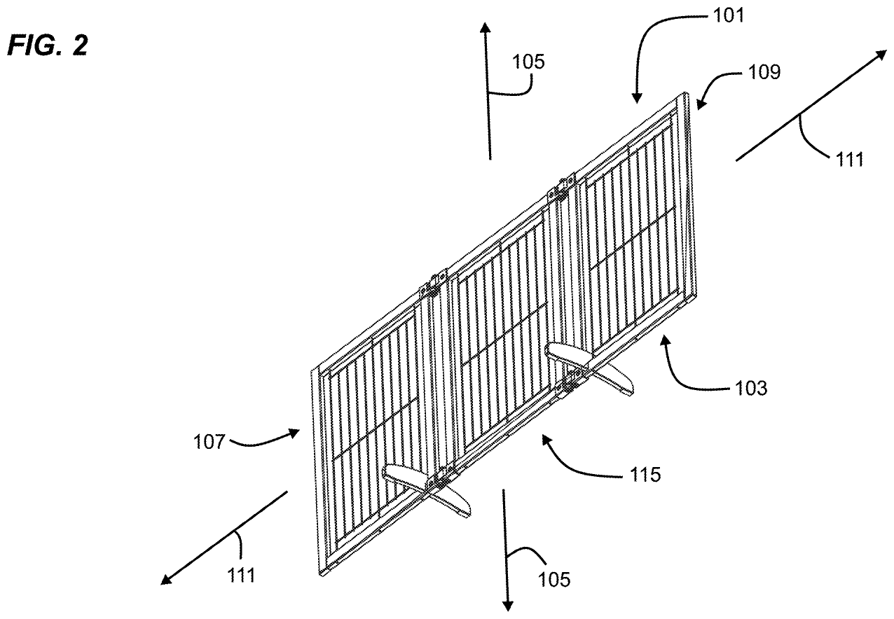

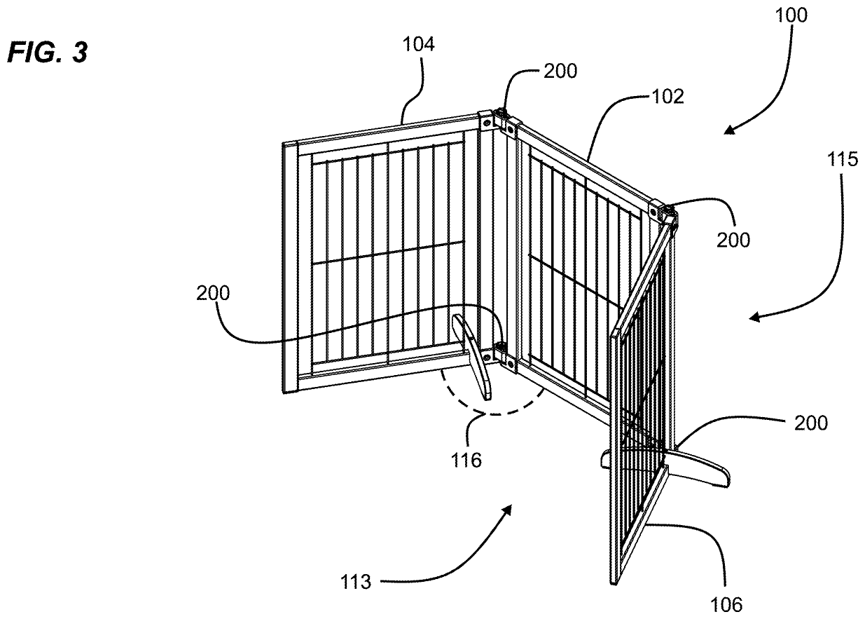

FIG. 1 is a perspective view of an example security gate 100 according to the present disclosure, the security gate being in a straight configuration. FIG. 2 is a further perspective view of the security gate 100 of FIG. 1 in the straight configuration. FIG. 3 is a further perspective view of the security gate 100 of FIG. 1, the security gate being in an angled configuration.

The angled configuration of FIG. 3 is just one example of many different lockable angled (i.e., non-straight) configurations for the security gate 100. The hinge assemblies of the gate 100 enable the gate 100 to adopt many different locked and unlocked angled configurations depending on specific use applications or needs. For example, different angled configurations can be selected based on the shape of the area desired to be closed off by the gate 100, the shape of an entryway that a gate blocks off, and so forth.

For example, the gate 100 can be configured as an L-shape, a U-shape with square corners, a staggered shape in which one of the side panels extends from the middle panel in one direction and the other of the side panels extends from the middle panel in an opposite directly, as well as many different positions in between those just described and the straight configuration. For instance, the configuration shown in FIG. 3 is in between the straight configuration and a U-shaped configuration with square corners.

Gates according to the present disclosure include a plurality of panels. The example gate 100 includes three panels, though alternatively a gate could have two panels, or four or more panels, depending on specific needs for a gate.

The hinge assembly principles of the present disclosure can be applied to use applications other than security gates, such as to pay pens or other enclosures made up of a plurality of panels that are hingedly-connected to one another.

According to the present disclosure, a structure (such as a security gate or another structure) includes multiple panels, with adjacent pairs of panels pivotally and lockingly coupled to each other by one or more hinge assemblies.

In the example gate 100, each adjacent pair of panels are coupled together with upper and lower hinge assemblies of identical configuration. In other examples, a single hinge assembly, or more than two hinge assemblies can couple adjacent panels. For example, a single hinge assembly can be generally centered along a vertical dimension of the gate. As another example, top and bottom hinge assemblies can be provided, as well as a third hinge assembly that is generally centered along a vertical dimension of the gate.

If the gate includes multiple hinge assemblies coupling the same two panels, one of the hinge assemblies can be a locking hinge assembly according to the present disclosure that includes a locking mechanism, and at least one other hinge assembly can have a different configuration, such as a hinge that provides pivotal coupling but does not include a locking mechanism.

Referring to FIGS. 1-2, the security gate 100 extends from a top 101 to a bottom 103 along a vertical axis 105, from a left side 107 to a right side 109 along a horizontal axis 111, and from a front 113 to a back 115 along another horizontal axis 117. The axes 105, 111 and 117 are mutually perpendicular.

Terms such as top, bottom, front, back, left, right, upper, lower, vertical, horizontal, and so forth, are used herein to aid in describing relative positioning of different components of the gate 100. These terms do not limit how the gate may be used or positioned in practice.

Referring to FIGS. 1-3, the security gate includes a middle panel 102, a first side panel (or left panel) 104 and a second side panel (or right panel) 106. Each side panel 104, 106 is pivotally coupled to the middle panel 102 with one or more (in this case, two) hinge assemblies 200.

The security gate 100 is free standing, supported by legs 110. The legs 110 can be integrated (e.g., of unitary construction) with the panels or separately manufactured. If separately manufactured, the legs 110 can be configured to mount to the panels, e.g., by frictional fit and/or with fasteners, such as screws.

In some examples, the legs 110 can be mounted at different selectable positions on the panels, depending on the configuration of the gate that is desired, to maximize the free-standing stability of the gate 100 in the chosen straight or angled configuration.

Each panel 102, 104, 106 includes an outer frame 112 and a plurality of bars 114 internal to the outer frame 112 and integral with, or attached to, the outer frame 112. The bars 114 can be horizontal and/or vertical and spaced apart from one another, to provide a barrier through which there is visibility. In other examples, one or more of the panels can include a lattice within the outer frame.

The panels 102, 104, 106 can be constructed of any suitable materials, such as rigid polymeric materials and/or metal materials.

Referring to FIG. 3, each of the side panels 104, 106 has been pivoted relative the middle panel 102 using the hinge assemblies 200 about a pivot angle relative to the straight configuration (FIGS. 1-2). For example, the panel 104 has been pivoted about an angle 116 relative to the panel 102. The angle 116 can be in a range from about 1 degree to about 100 degrees, or more. Similarly, the panel 106 can be pivoted about an angle in a range from about 1 degree to about 100 degrees or more.

In the example angled configuration shown, both panels 104 and 106 are pivoted frontwards (e.g., towards the front 113 of the gate 100). In other examples, one or both of the panels 104 and 106 can be pivoted rearwards (e.g., towards the back 115 of the gate 100) according to any of the same ranges of angles just described.

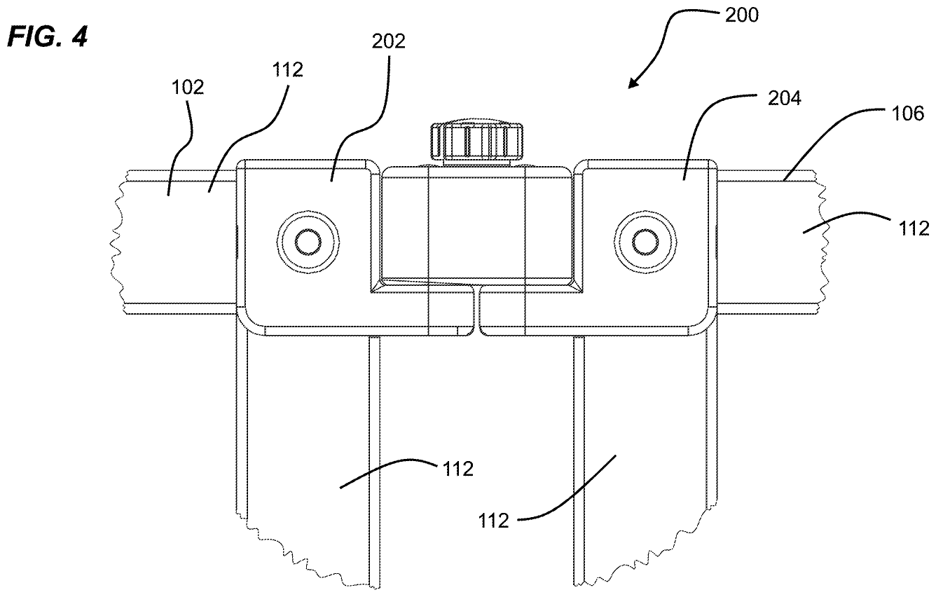

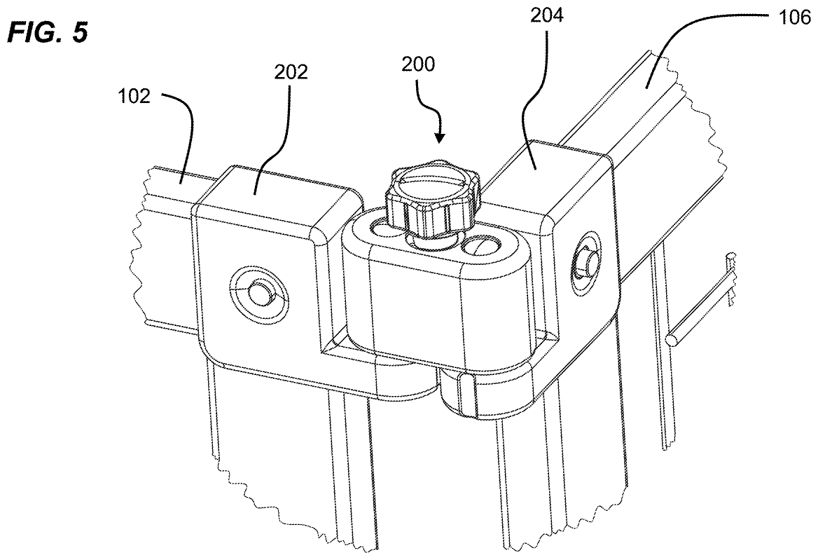

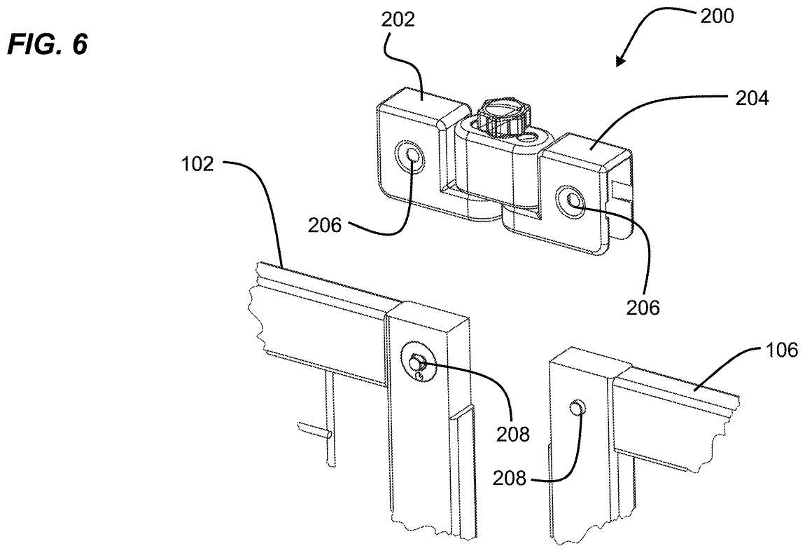

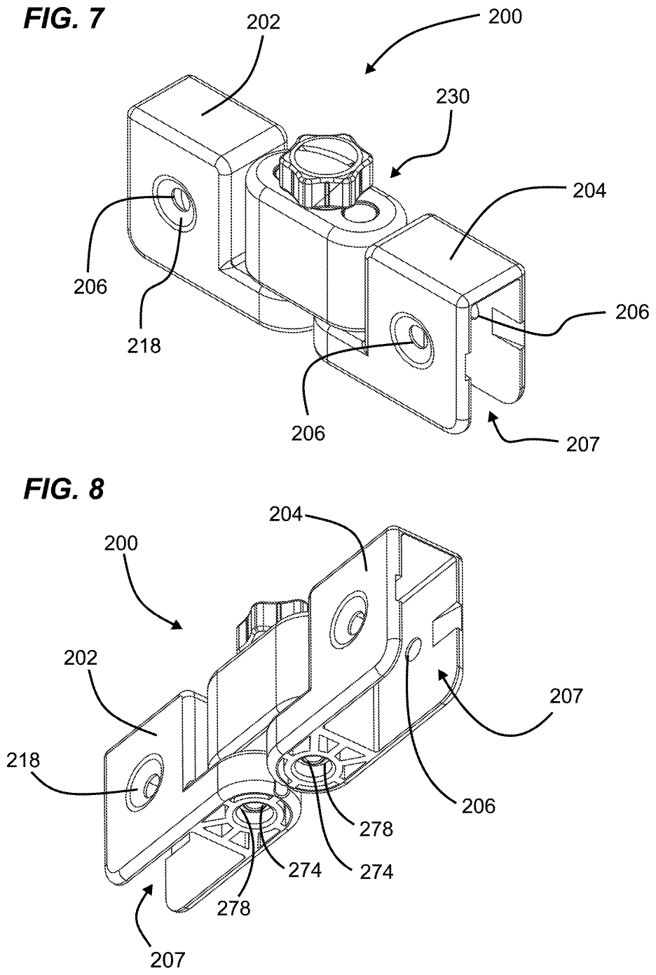

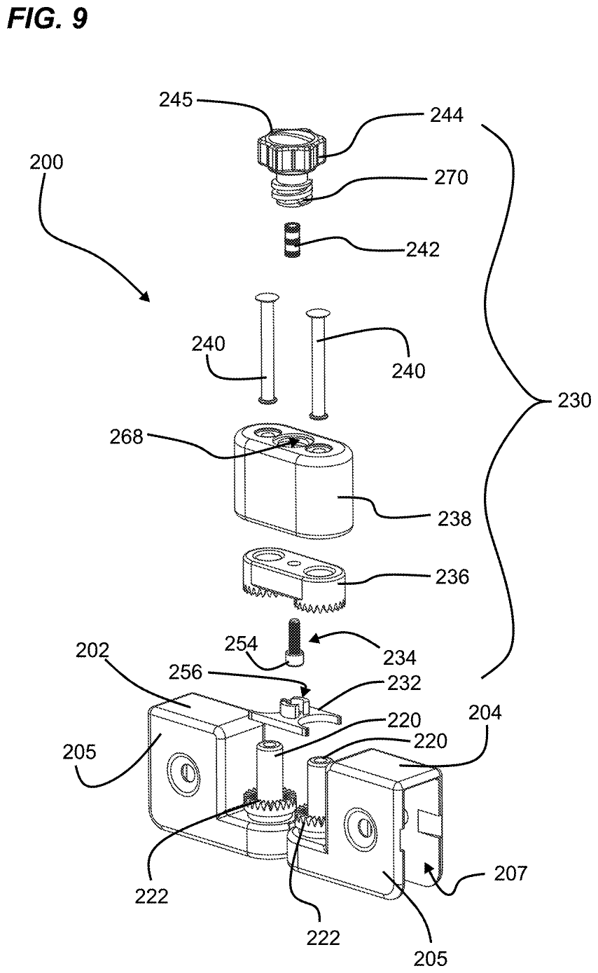

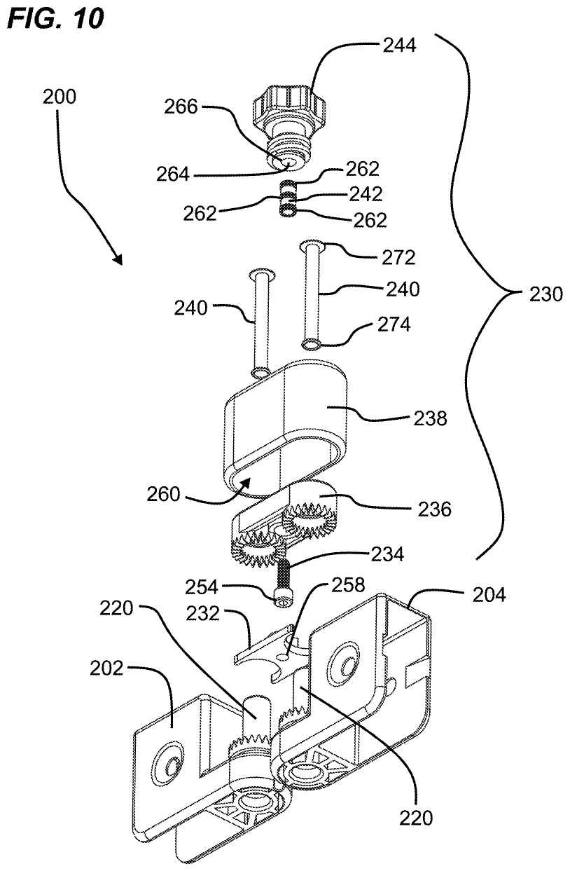

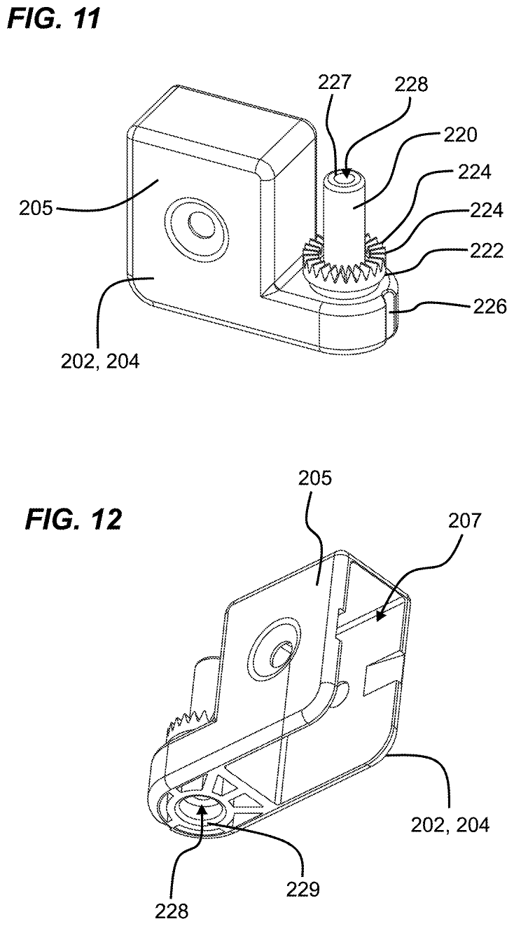

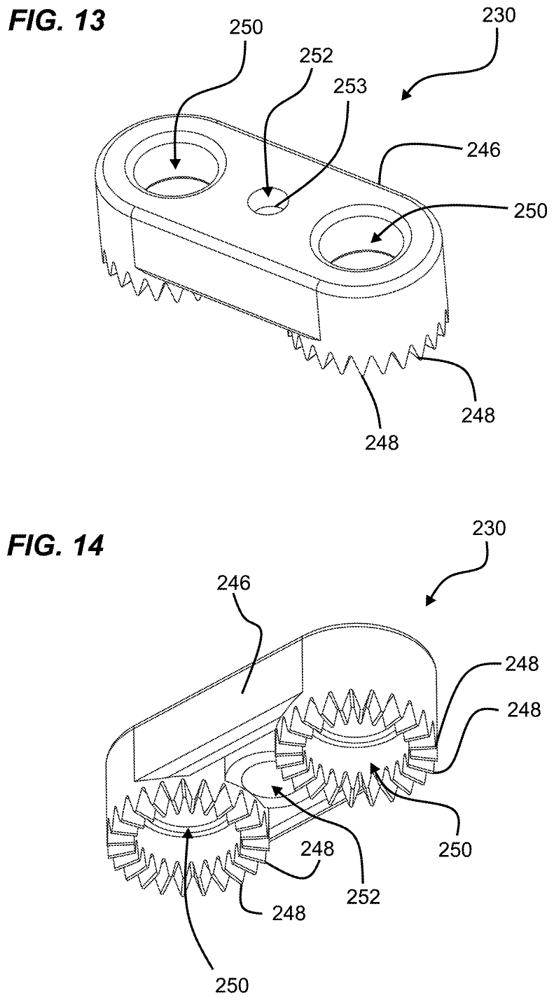

Referring to FIGS. 4-14, one of the hinge assemblies 200 will be described.

The hinge assembly 200 includes brackets 202 and 204 that mount to the outer frames 112 of two adjacent panels, such as the panels 102 and 106. Each bracket 202, 204 includes a body 205. The body 205 defines a socket 207 configured to receive a portion (e.g., a corner of an outer frame) of a panel 102, 104, 106. In the example shown, the bracket 202 mounts to the outer frame 112 of the panel 102, and the bracket 204 mounts to the outer frame 112 of the panel 106.

The body 205 of the bracket 202, 204 includes receivers 206 that define fully enclosed openings. For each bracket, the receivers can be aligned with each other at the front and the back of the bracket.

The receivers are configured to receive pegs 208. Pegs 208 can be provided in pairs aligned with each other at the front and back of each panel. In some examples, one peg in each pair can be a spring-loaded button, which can be pressed to mount a bracket to the panel and then released to lock the bracket to the panel. Ramped recesses 218 can facilitate push-access to the pegs to release and remove the assembly 200 from its panels.

The body 205 of each bracket 202, 204 includes a post 220 and a locking element 222. In this example, the locking element 222 includes a plurality of teeth 224 arranged circumferentially in a horizontal circular ring around the post 220. The post 220 extends vertically upward through and above the locking element 222.

The body 205 of each bracket 202, 204 can define an access recess 226, which can facilitate access of a portion of the subassembly 230 from the bottom of the bracket 202, 204. When the gate 100 is in the straight configuration, the access recesses 226 of facing, adjacent brackets 202, 204 are aligned parallel to the axis 111 (FIG. 2).

In some examples, features of each bracket 202, 204, such as the post 220 and the locking element 222 can be of unitary construction with the body 205. In other examples, one or more of these features can be manufactured separately and then attached to the body of the bracket.

The post 220 of each bracket defines a vertically elongate through passage 228 extending from a bottom opening 229 through to a top opening 227.

To lockingly and pivotally couple two panels to each other, a subassembly 230 of the hinge assembly 200 is operatively connected to a pair of brackets 202 and 204. The brackets 202 and 204 can be structurally identical to each other.

The subassembly 230 includes a separator catch 232, a separator 234, a locking element 236, a housing 238, one or more pins 240, a gripper 242 and an actuator 244. In this example, the separator 234 is a threaded fastener, such as a screw. In this example, the actuator 244 is a threaded fastener, such as a screw that includes a knob 245. The actuator 244 can be considered a downward oriented upper threaded fastener, and the separator 234 can be considered an upward oriented lower fastener, such that the ends of the shafts of the fasteners face each other. In this example, the gripper 242 is a hollow sleeve.

The locking element 236 includes a body 246 and two sets of circumferentially arranged teeth 248 arranged in circular rings about vertical through holes 250. The body 246 also defines a vertical through opening 252 positioned between the two sets of teeth 248. A shoulder 253 that partially defines the through opening 252 serves as a downward facing interface positioned to contact the head 254 of the separator 234 as the separator 234 advances upward by action of the actuator 244.

In the locked configuration of the hinge assembly 200, the teeth 248 intermesh with and thereby interlock with the teeth 224 of the brackets 202, 204, preventing rotation of the posts 220 about the pins 240.

The catch 232 is mounted about the posts 220 of adjacent brackets 202 and 204 below the locking elements 222. The catch 232 includes a seat 256 configured to prevent the head 254 of the separator 234 from falling downward and separating completely from the rest of the assembly, while allowing access to a tool (e.g., a screwdriver) via a through hole 258 to access the head 254 of the separator 234 from below the assembly 200. The catch 232 can also advantageously minimize the chances of the actuator separator 234 becoming loose and posing as a choking hazard.

The housing 238 receives and retains the pins 240 within the through passages 228 of the posts 220. The pins 240 define longitudinal pivot axes that are oriented vertically and extend centrally and longitudinally through the pins 240. When the assembly 200 is in an unlocked configuration, the brackets 202, 204 can pivot about these pivot axes of the pins 240, respectively.

The housing 238 also receives the locking element 236 in a pocket 260 defined by the housing 238. The pocket 260 is configured to allow the locking element 236 to move up and down along a post 220 within the pocket 260 between locked and unlocked configurations of the assembly 200.

The gripper 242 includes exterior gripping elements 262, such as ribs or ridges. The gripping elements 262 can frictionally grip (e.g., with a biting action) an interior surface of a receiver 266 defined by the actuator 244. Thus, in some examples, the gripper 242, or at least a portion of the gripper 242, is secured within the receiver 266 of the actuator 244.

The housing 238 also defines a threaded opening 268 configured to threadably engage a thread 270 of the actuator 244. The threaded opening 268 is positioned between the receiving locations defined by the housing 238 for the two pins 240. Thus, the threaded opening 268 is positioned between the pins 240. The thread 270 and/or the thread of the threaded opening 268 can be configured to prevent disengagement of the actuator 244 from the housing 238. That is, the thread 270 and/or the threaded opening 268 can be configured to prevent separation of the actuator 244 from the housing 238 by rotation of the knob 245, advantageously minimizing the chances of the actuator 244 becoming loose and posing as a choking hazard.

When the assembly 200 is assembled, the pins 240 extend though the housing 238, through the through holes 250 of the locking element 230, and through the posts 220, with lips 272, 274 of each pin 240 being vertically retained by, respectively, a shoulder 276 defined by the housing 238 and a shoulder 278 defined by the body 205 of a bracket 202, 204.

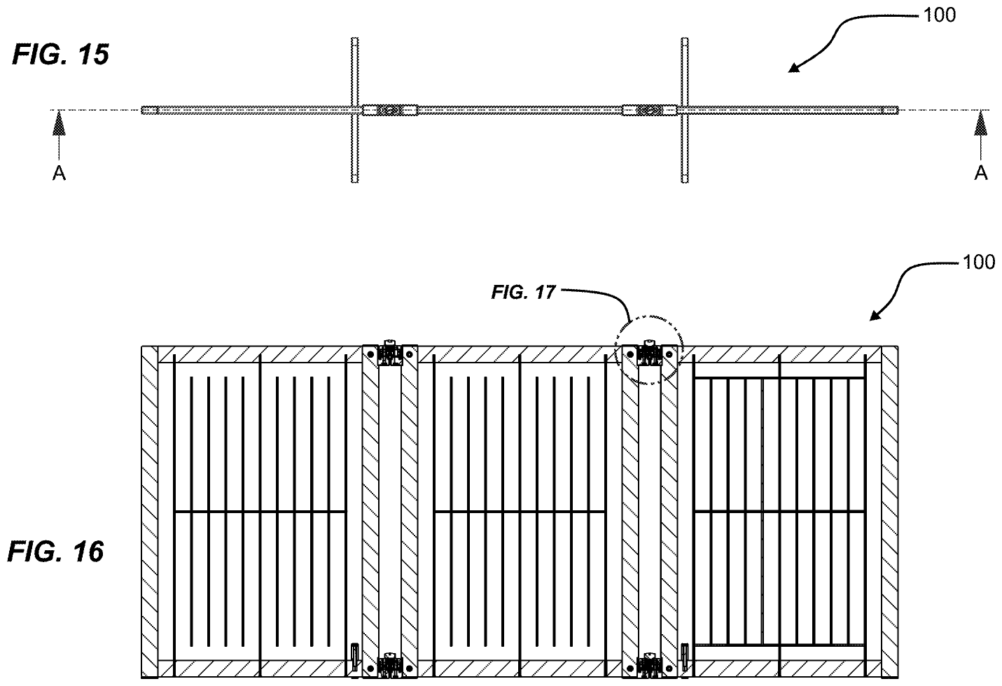

FIG. 15 is a top view of the security gate 100 of FIG. 1.

FIG. 16 is a cross-sectional view of the security gate 100 of FIG. 1 along the line A-A in FIG. 15.

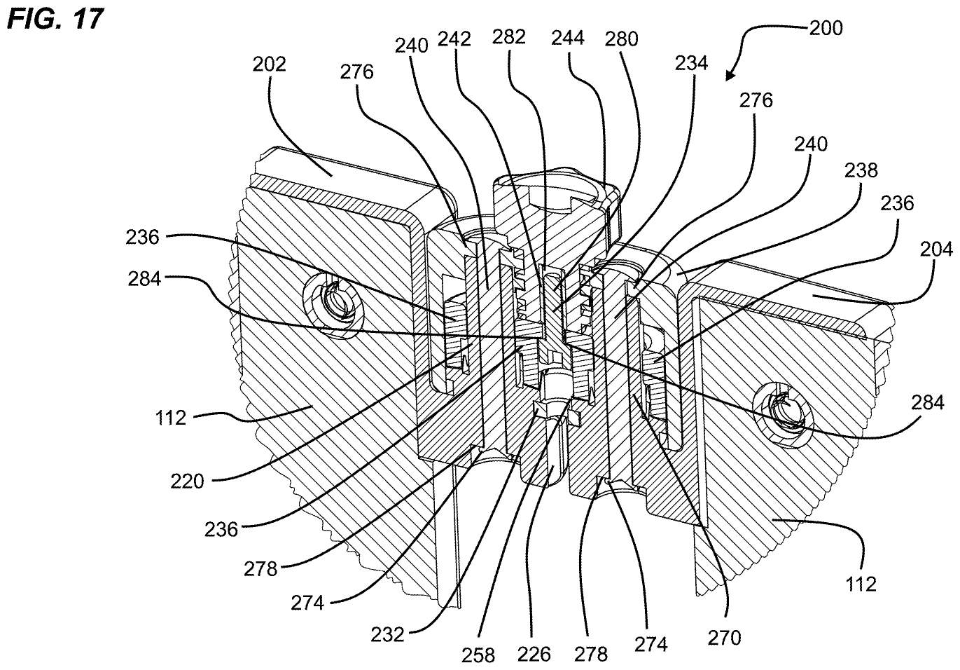

FIG. 17 is an enlarged, perspective view of a portion of the security gate 100 shown in FIG. 16, with the hinge assembly 200 being in a straight and locked configuration.

Referring to FIG. 17, the shaft 280 of the separator 234 is grippingly received within the sleeve 242. In some examples, the threads of the shaft 280 can grip (e.g., with a biting action) an interior surface 282 of the sleeve 242. In some examples, the separator 234 can be screwed upward into position within the sleeve 242.

An interface 284 is formed between an upward facing surface of the head 254 of the separator 234 and a downward facing surface of the locking element 236, with these surfaces abutting each other at the interface 284.

In the configuration of FIG. 17, the teeth of the locking element 236 engage the teeth of the brackets 202, 204, preventing rotation about the pins 240, and thereby locking the gate 100 in the straight configuration.

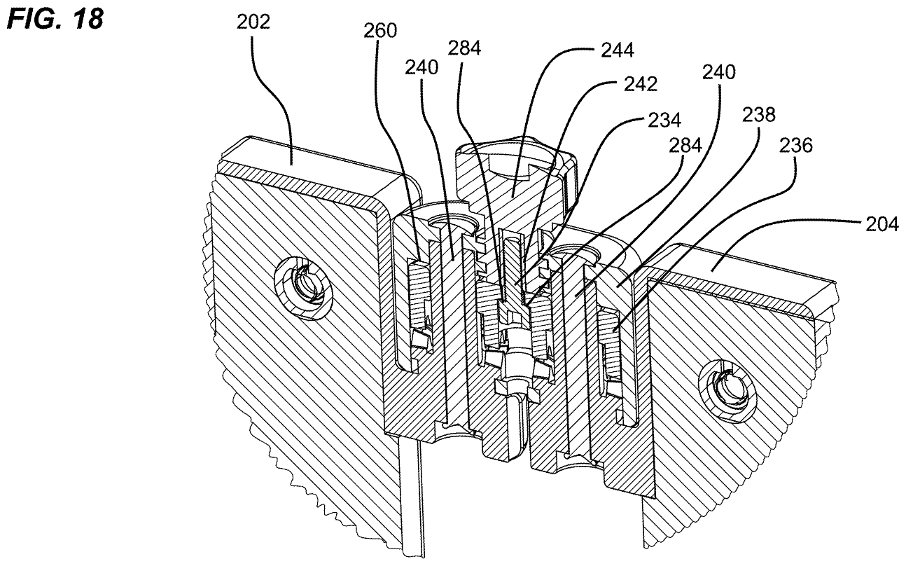

FIG. 18 is an enlarged perspective view of the portion of FIG. 17, with the hinge assembly 200 being in a straight and unlocked configuration.

Referring to FIG. 18, the actuator 244 has been rotated about a rotation axis parallel to the axis 105 (FIG. 1) relative to the configuration of FIG. 17. Due to the threaded engagement of the actuator 244 with the housing 238, the rotation of the actuator 244 has caused the actuator 244 to move upward relative to the housing 238. In so doing, the actuator carries the sleeve 242, which in turn carries the separator 234, causing the separator 234 to push at the interface 284 the locking element 236 upward within the pocket 260 of the housing 238 such that the teeth of the locking element 236 vertically disengage the teeth of the brackets 202, 204, thereby unlocking the hinge assembly 200 and allowing the brackets 202, 204 to pivot about the pins 240.

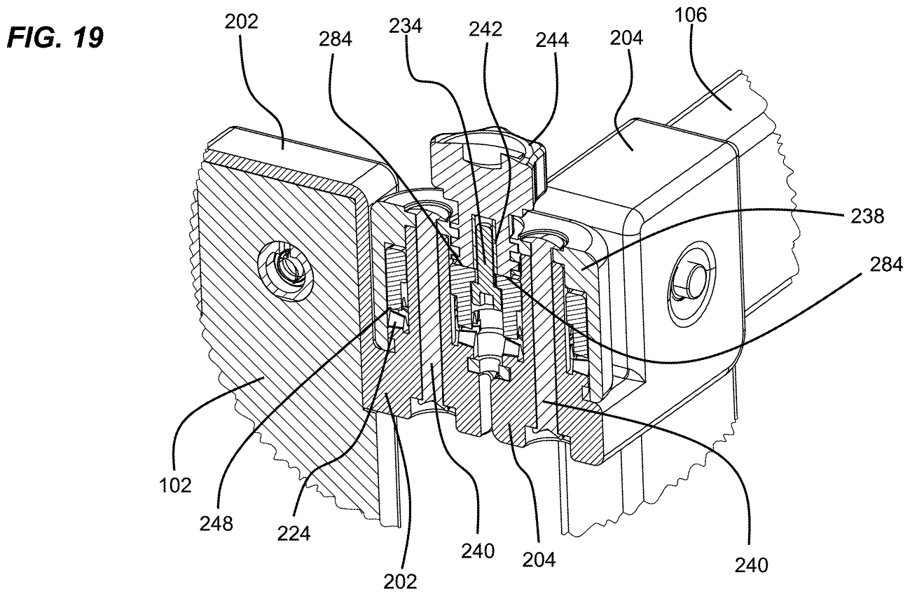

For example, and as shown in FIG. 19, since the teeth 248 of the locking element 238 are disengaged from the teeth 224 of the bracket 204, the bracket 204, together with the panel 106 can be pivoted about the pin 240a (corresponding to one of the pins 240) to the pivoted position shown, which is approximately 90 degrees from the straight configuration.

Due to the large number of circumferentially arranged interlocking teeth 224, 248, the hinge assembly 200 can be pivoted and re-locked at a large number of selectable positions.

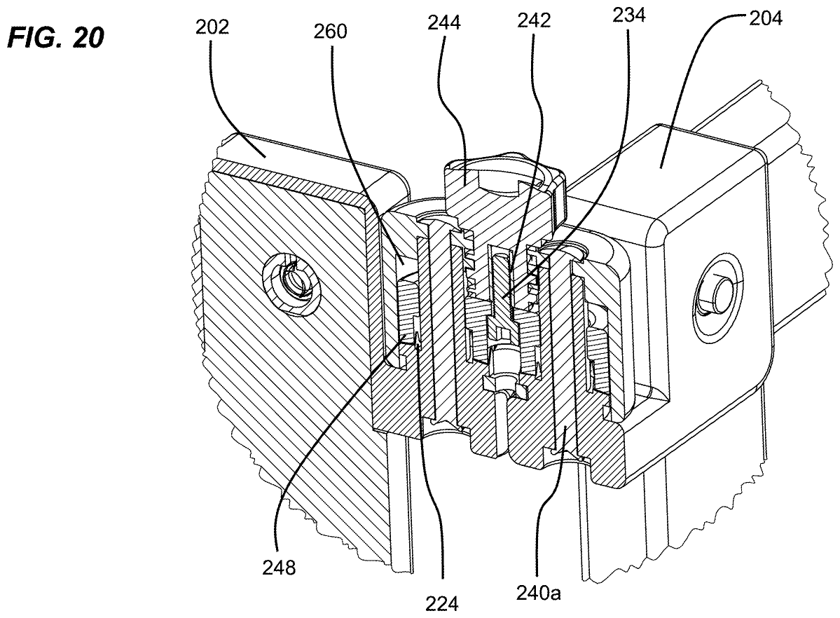

As shown in FIG. 20, the angled configuration of the assembly 200 of FIG. 19 is locked by rotating the actuator 244 in the opposite rotation direction used to generate the unlocked configuration. Rotation of the actuator 244 has caused the actuator 244 to move downward relative to the housing 238. In so doing, the actuator carries the sleeve 242, which in turn carries the separator 234, causing the separator 234 to push at the interface 284 the locking element 236 downward within the pocket 260 of the housing 238 such that the teeth 248 of the locking element 236 vertically re-engage the teeth 224 of the brackets 202, 204, thereby re-locking the hinge assembly 200 and preventing the brackets 202, 204 to pivot about the pins 240.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A security gate, comprising:
panels; and
a hinge assembly having an unlocked configuration and a locked configuration, the hinge assembly coupling the panels to each other, the hinge assembly including:
a bracket that mounts to one of the panels;
a pin about which the bracket is configured to pivot when the hinge assembly is in the unlocked configuration;
a locking element; and
an actuator, the actuator being configured to cause the locking element to lockingly engage and to disengage the bracket, the hinge assembly being in the locked configuration when the locking element lockingly engages the bracket.

2. The security gate of claim 1,
wherein the locking element and the bracket include intermeshing teeth.

3. The security gate of claim 1, wherein the actuator includes a threaded fastener.

4. The security gate of claim 3, wherein rotation of the actuator causes the locking element to move within a housing of the hinge assembly.

5. The security gate of claim 4, further comprising a separator, wherein rotation of the actuator causes the separator to push on the locking element.

6. The security gate of claim 5, wherein the separator includes a fastener.

7. The security gate of claim 5, wherein the separator and the actuator include shafts extending from heads in opposite directions.

8. The security gate of claim 5, further comprising a catch configured to stop the separator from falling out of a housing of the hinge assembly.

9. The security gate of claim 5, wherein the bracket defines an access recess configured to provide access to the separator from a bottom of the hinge assembly.

10. The security gate of claim 1, wherein the security gate is configured to be free-standing.

11. The security gate of claim 1, further comprising:
another bracket that mounts to another one of the panels; and
another pin about which the another bracket is configured to pivot when the hinge assembly is in the unlocked configuration, the pin and the another pin being on opposite sides of the actuator.

12. The security gate of claim 1,
wherein the bracket includes a post; and
wherein the locking element fully surrounds the post.

13. The security gate of claim 12, wherein the locking element moves along the post between the unlocked configuration and the locked configuration of the hinge assembly.

14. The security gate of claim 12, wherein the pin is received in the post.

15. The security gate of claim 1, wherein the bracket mounts to the one of the panels with a spring-loaded button.

16. A hinge assembly for a security gate, comprising:
a bracket;
a pin about which the bracket is configured to pivot when the hinge assembly is in an unlocked configuration;
a locking element; and
an actuator, the actuator being configured to rotate to cause the locking element to lockingly engage and to disengage the bracket, the hinge assembly being in a locked configuration when the locking element lockingly engages the bracket.

17. The hinge assembly of claim 16,
wherein the bracket includes a post; and
wherein the locking element and the bracket include intermeshing teeth that fully surround the post.

18. The hinge assembly of claim 16, further comprising:
a separator including a fastener,
wherein rotation of the actuator causes the separator to push on the locking element; and
wherein the separator and the actuator include shafts extending from heads in opposite directions.

19. The hinge assembly of claim 16, further comprising a catch configured to stop the separator from falling out of a housing of the hinge assembly.

20. A security gate, comprising:
panels; and
a hinge assembly having an unlocked configuration and a locked configuration, the hinge assembly coupling the panels to each other, the hinge assembly including:
brackets that mount to the panels, the brackets including posts and first locking elements including first teeth;
pins positioned within the posts, the pins being configured to pivot when the hinge assembly is in the unlocked configuration;
a second locking element including second teeth; and
an actuator positioned between the pins and between the posts, the actuator being configured to rotate to cause the second locking element to move along the posts such that the second teeth of the second locking element lockingly engage and disengage the first teeth of the first locking elements, the hinge assembly being in the locked configuration when the second teeth of the second locking element lockingly engage the first teeth of the first locking elements.
